(19) United States
(12) Patent Application Publication
(10) Pub. No.: US 2025/0249834 A1
(43) Pub. Date: Aug. 7, 2025

(54) CONSOLE MODULE AND VEHICLE COCKPIT INCLUDING SAME

(71) Applicant: HYUNDAI MOBIS CO., LTD., Seoul (KR)

(72) Inventors: Yoong Kyung HWANG, Yongin-si (KR); Chi Yun HAN, Yongin-si (KR); Ju Yeon JUNG, Yongin-si (KR)

(73) Assignee: HYUNDAI MOBIS CO., LTD., Seoul (KR)

(21) Appl. No.: 19/026,930

(22) Filed: Jan. 17, 2025

(30) Foreign Application Priority Data
Feb. 1, 2024 (KR) 10-2024-0016244

(51) Int. Cl. B60R 7/06; B60N 3/00; B60N 3/10; B62D 25/14

(52) U.S. Cl. CPC B60R 7/06; B60N 3/001; B60N 3/104; B62D 25/14

(57) ABSTRACT

A console module disclosed includes a case positioned below a dashboard of a vehicle, and a connection portion configured to connect the case to the dashboard, allowing the case, positioned below the dashboard, to move between a non-use position and a use position, in which the case protrudes further rearward than in the non-use position.

### CROSS-REFERENCE TO RELATED APPLICATIONS

This application claims priority from and the benefit of Korean Patent Application No. 10-2024-0016244, filed on Feb. 1, 2024, which is hereby incorporated by reference for all purposes as if set forth herein.

### TECHNICAL FIELD

Exemplary embodiments according to the present disclosure relate to a console module installed in a driver seat of a vehicle and to a vehicle cockpit including the same.

### BACKGROUND

A vehicle that conventionally includes an internal combustion engine includes a transmission. For the operation of the transmission, a transmission input device, such as a lever or dial, is generally positioned in the space between the driver seat and passenger seat in the interior space of the vehicle. In addition, a console box is positioned between the driver seat and passenger seat to store items or support the driver's arms.

However, in the case of an electric vehicle that is driven solely by power of a motor, a transmission and a transmission input device are not required. Therefore, a device is required that allows occupants to use electronic devices and store items while using the interior space of the vehicle more spaciously and conveniently.

The related art of the present disclosure is disclosed in Korean Patent No. 10-1792957 (registered on Oct. 26, 2017, and entitled “A Console Box For Car With LED”).

### SUMMARY

Various embodiments of the present disclosure are directed to providing a console module installed on the vehicle's dashboard and a vehicle cockpit including the same, allowing occupants to use the interior space of the vehicle more spaciously and conveniently.

A console module according to the present disclosure includes a case positioned below a dashboard of a vehicle, and a connection portion configured to connect the case to the dashboard, allowing the case, positioned below the dashboard, to move between a non-use position and a use position, in which the case protrudes further rearward than in the non-use position.

The case may pivot between the non-use position and the use position with the connection portion as a pivot point.

The console module may further include a side table that includes a flat plate portion configured to pivot between a horizontally lying position and an upright position that intersects the lying position, and be supported on the case.

The console module may further include a pocket installed on the case and configured with a pocket door capable of opening or closing.

The console module may further include an electronic device installed in the case.

The electronic device may include at least one of a refrigerator, a cooling cup holder, and a heating cup holder.

The case may include an outer housing and an inner frame inserted into the outer housing so as to protrude from the outer housing.

A vehicle cockpit according to the present disclosure includes a dashboard positioned in an interior space of a vehicle, and a console module that includes a case positioned below the dashboard and a connection portion configured to connect the case to the dashboard, allowing the case, positioned below the dashboard, to move between a non-use position and a use position, in which the case protrudes further rearward than in the non-use position.

The vehicle cockpit may further include a driver seat positioned behind the dashboard in the interior space of the vehicle and a passenger seat adjacent to the driver seat. The case is positioned between the driver seat and the passenger seat when in the use position.

The vehicle cockpit may further include an actuator that provides power to move the case from the non-use position to the use position, and from the use position to the non-use position.

In the embodiment of the present disclosure, a console module for storing items is positioned below the dashboard. When the console module is in use, the console module protrudes rearward, and when the console module is not in use, the console module is positioned so as not to protrude rearward. Therefore, occupants seated in the driver seat or passenger seat may conveniently use the console module when in use. When the console module is not in use, occupants may comfortably rest by fully stretching or spreading their legs in the interior space of the vehicle without being hindered by the console module.

In the embodiment of the present disclosure, the console module, in which pockets for storing items and electronic devices are installed, is installed under the dashboard. Thus, there is no need to install a console box between the driver seat and passenger seat. This makes the interior space of the vehicle more spacious and convenient to use, for example, allowing occupants to move easily from the driver seat to the passenger seat or from the passenger seat to the driver seat when needed.

### BRIEF DESCRIPTION OF THE DRAWINGS

FIG. 1 is a perspective view of a vehicle cockpit according to an embodiment of the present disclosure, illustrating a case of a console module in a use position.

FIG. 2 is a perspective view of a vehicle cockpit according to an embodiment of the present disclosure, illustrating a case of a console module in a non-use position.

FIG. 3 is a perspective view of a console module according to an embodiment of the present disclosure, illustrating a protruding inner frame and a folded side table.

FIG. 4 is a perspective view of a console module according to an embodiment of the present disclosure, illustrating a protruding inner frame and an unfolded side table.

FIG. 5 is a perspective view of a console module according to an embodiment of the present disclosure, illustrating a protruding inner frame and an opened pocket.

FIG. 6 is a perspective view of a console module according to another embodiment of the present disclosure.

### DETAILED DESCRIPTION

Embodiments of a console module and a vehicle cockpit including the same according to the present disclosure will be described hereinafter in detail with reference to the accompanying drawings. The terminology used herein is intended to appropriately describe preferred embodiments of the present disclosure, and may vary depending on the intentions of the user or operator or the conventions of the field to which the present disclosure pertains. Therefore, the definition of the terminology should be made according to the overall disclosure set forth herein.

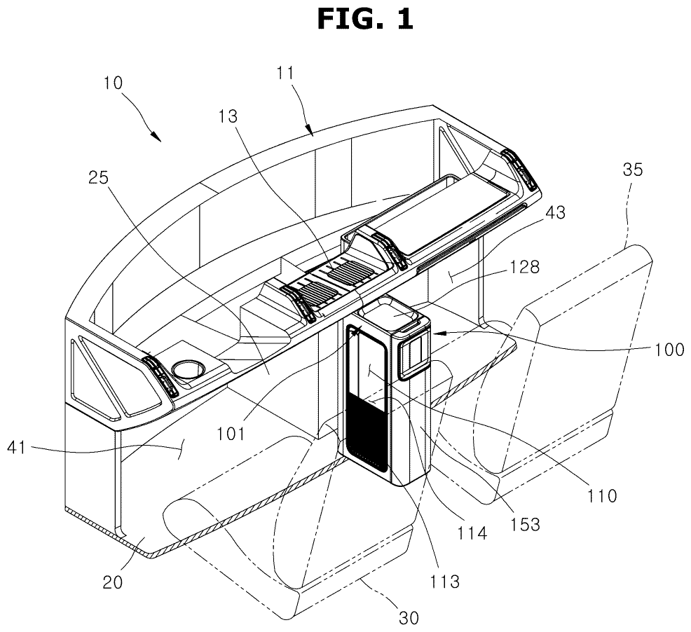

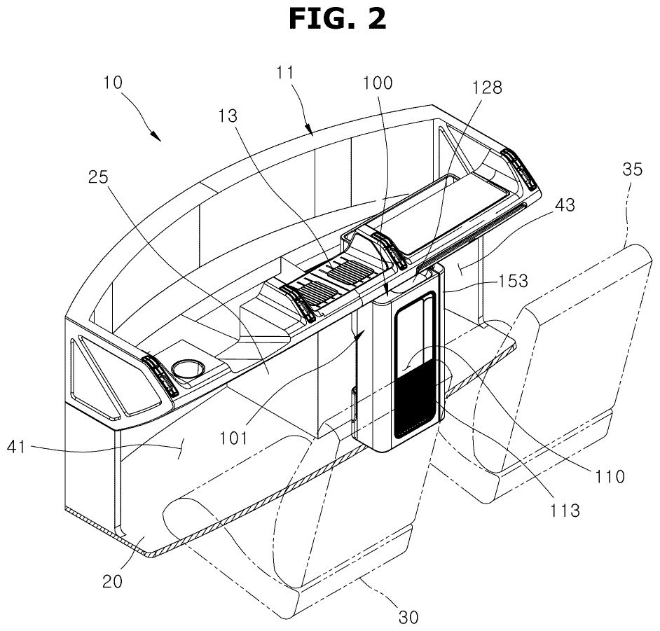

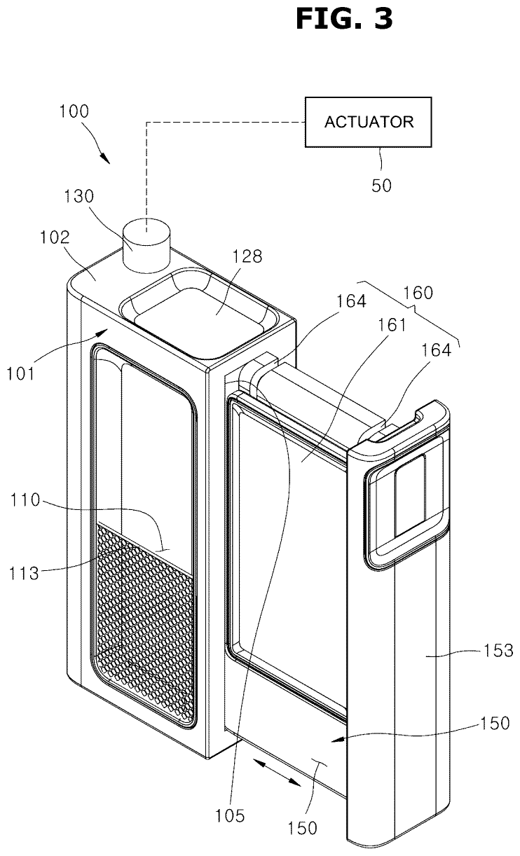

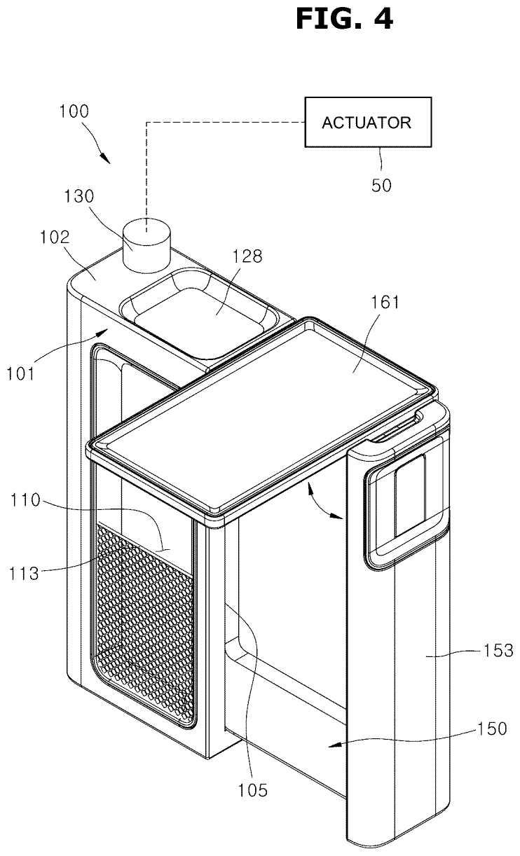

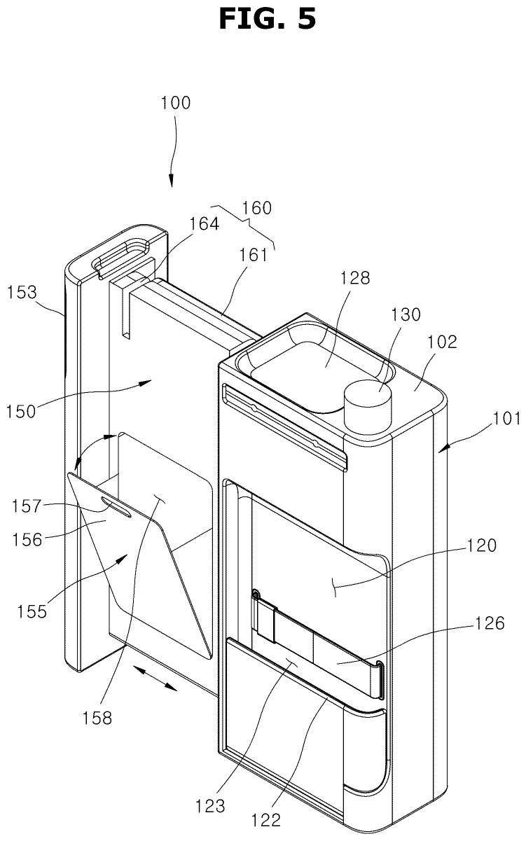

FIG. 1 is a perspective view of a vehicle cockpit according to an embodiment of the present disclosure, illustrating a case of a console module in a use position. FIG. 2 is a perspective view of a vehicle cockpit according to an embodiment of the present disclosure, illustrating a case of a console module in a non-use position. FIG. 3 is a perspective view of a console module according to an embodiment of the present disclosure, illustrating a protruding inner frame and a folded side table. FIG. 4 is a perspective view of a console module according to an embodiment of the present disclosure, illustrating a protruding inner frame and an unfolded side table. FIG. 5 is a perspective view of a console module according to an embodiment of the present disclosure, illustrating a protruding inner frame and an opened pocket.

Referring to FIGS. 1 to 5, a vehicle cockpit 10 according to an embodiment of the present disclosure is provided in an interior space of a vehicle and includes a dashboard 11 and a console module 100. The dashboard 11 may be positioned below a windshield of the vehicle. Although not illustrated in FIGS. 1 and 2, the dashboard 11 may be equipped with, for example, an instrument panel, a glove box, and a display panel.

The vehicle cockpit 10 may further include a driver seat 30 positioned behind the dashboard 11 in the interior space of the vehicle, and a passenger seat 35 adjacent to the driver seat 30. The driver seat 30 may be configured to accommodate a driver, and the passenger seat 35 may be configured to accommodate a passenger.

Below the dashboard 11, a floorboard 20 may be installed to support the feet of an occupant seated in the driver seat 30 or the passenger seat 35. Between the dashboard 11 and the floorboard 20, a driver seat's leg rest 41, which serves as space for the legs of an occupant seated in the driver seat 30, and a passenger seat's leg rest 43, which serves as space for the legs of an occupant seated in the passenger seat 35, may be provided. The driver seat's leg rest 41 may be provided in front of the driver seat 30, and the passenger seat's leg rest 43 may be provided in front of the passenger seat 35.

In addition, a partition 25 may be provided between the dashboard 11 and the floorboard 20 to separate the driver seat's leg rest 41 from the passenger seat's leg rest 43. The partition 25 may be installed below the central portion 13 of the dashboard, positioned at the midpoint in the width direction of the vehicle.

The console module 100 includes a case 101 and a connection portion 130. The case 101 is positioned below the dashboard 11. For example, the case 101 may be positioned between the central portion 13 of the dashboard and the floorboard 20, behind the partition 25.

The case 101 may include an outer housing 102 and an inner frame 150. The outer housing 102 may have a substantially hexahedral shape and extend in the vertical direction. The inner frame 150 may be inserted into the outer housing 102 and has a portion protruding from the outer housing 102.

The outer housing 102 may have an inner frame storage hole 105 into which the inner frame 150 is inserted. The inner frame storage hole 105 may allow the inner frame 150 to slide relative to the outer housing 102 and be inserted into the outer housing 102, or conversely, allow the inner frame 150 to protrude outward from the outer housing 102.

The case 101 may further include a bezel 153 on an edge portion of the inner frame 150 that is not inserted into the inner frame storage hole 105. For example, a user of the console module 100 may grasp the bezel 153 by hand and pull or push this bezel, allowing the inner frame 150 to protrude outward from the outer housing 102 or to be inserted into the outer housing 102.

Although not illustrated in the drawings, the console module 100 may further include an actuator for moving an inner frame, which provides power to protrude the inner frame 150 outward from the outer housing 102 or insert the inner frame 150 into the outer housing 102. In this case, an input device for entering a command to move the inner frame 150 relative to the outer housing 102 may be provided on the bezel 153. The user may operate the input device provided on the bezel 153 to automatically protrude the inner frame 150 outward from the outer housing 102 or insert the inner frame 150 into the outer housing 102.

The connection portion 130 connects the case 101 to the dashboard 11, allowing the case 101 to move between a non-use position and a use position. For example, the connection portion 130 may protrude from an upper portion of the outer housing 102 and be fastened to the central portion 13 of the dashboard. The console module 100 shown in FIGS. 3 to 5 is equipped only with the connection portion 130 fastened to the dashboard 11. However, this is exemplary, and the console module of the present disclosure may further include a connection portion fastened to the floorboard 20.

The case 101 being in the use position refers to a state in which the case 101 protrudes further rearward compared to when in the non-use position. As illustrated in FIG. 2, when the case 101 is in the non-use position, the case 101 may not protrude further rearward than the rear end of the dashboard 11.

On the other hand, as illustrated in FIG. 1, when the case 101 is in the use position, at least a portion of the case 101 may protrude further rearward than the rear end of the dashboard 11. In particular, the bezel 153 of the case 101 may protrude further rearward from the dashboard 11 so as to be closer to the driver seat 30 and the passenger seat 35 when in the use position compared to when in the non-use position.

The case 101 may pivot between the non-use position and the use position, with the connection portion 130 functioning as a pivot point. For example, when moving from the use position to the non-use position, and from the non-use position to the use position, the case 101 may pivot 90° in opposite directions with the connection portion 130 as the pivot point.

When in the use position, the case 101 may be positioned between the driver seat 30 and the passenger seat 35. The console module 100 illustrated in FIGS. 1 and 2 pivots relative to the dashboard 11 to change positions between the non-use position and the use position. However, this is exemplary, and in another embodiment of the present disclosure, the console module may also change positions between the non-use position and the use position by moving linearly forward and backward relative to the dashboard.

The vehicle cockpit 10 may further include an actuator 50 that provides power to move the case 101 from the non-use position to the use position, and from the use position to the non-use position. The actuator 50 may include an electric motor (not illustrated). The actuator 50 may, for example, be installed on the dashboard 11 or on the console module 100.

When the vehicle cockpit 10 includes the actuator 50, an input device for entering a command to pivot the case 101 relative to the dashboard 11 may be provided on the dashboard 11 or on the bezel 153. The user may operate the input device provided on the dashboard 11 or the bezel 153 to pivot the case 101 from the non-use position to the use position, or from the use position to the non-use position.

The console module 100 may further include a plurality of pockets 113, 122, 155, a charging plate 128, and a side table 160. Among the plurality of pockets 113, 122, 155, a first pocket 113 and a second pocket 122 may be provided on opposite sides of the outer housing 102, respectively.

The first pocket 113 may include an elastically stretchable mesh that covers

approximately half of the lower portion of a first side groove 110 recessed in one side of the outer housing 102. The first pocket 113 may be a pocket that has an entrance 114 that remains open upward, allowing items to be placed in and taken out.

The second pocket 122 may include a hard door made of plastic or metal that covers approximately half of the lower portion of a second side groove 120 recessed in the other side of the outer housing 102. The second pocket 122 may be a pocket that has an entrance 123 that remains open upward, allowing items to be placed in and taken out.

The console module 100 may further include an elastic band 126 to press and secure items such as papers, notebooks, or folders against the other side of the outer housing 102. These items may be supported at their bottom portions by being inserted into the second pocket 122, which is positioned on the other side of the outer housing 102 where the second side groove 120 is formed.

The third pocket 155 may be installed on the inner frame 150. The third pocket 155 may only be exposed when the inner frame 150 protrudes outward from the outer housing 102. The third pocket 155 may include a pocket door 156 configured to be opened or closed. For example, a lower portion of the pocket door 156 may be coupled to the inner frame 150 by a hinge (not illustrated).

When the pocket door 156 pivots around the hinge at the lower portion thereof to open, an entrance 158 of the third pocket 155, which allows items to be placed in and taken out, may open upward. The pocket door 156 may include a handle 157 at the upper portion thereof, allowing the user to grasp the pocket door 156 for opening or closing.

Although not illustrated in the drawings, the console module 100 may further include an actuator for opening/closing a pocket door, which provides power to open or close the pocket door 156. In this case, an input device for entering a command to open or close the pocket door 156 may be provided on the bezel 153. The user may operate the input device provided on the bezel 153 to open or close the pocket door 156.

The console module 100 may further include the side table 160 on which portable electronic devices such as laptop computers and tablet computers, food, beverages and the like may be placed. The side table 160 may only be exposed when the inner frame 150 protrudes outward from the outer housing 102.

The side table 160 may include a plate-shaped flat plate portion 161 and a hinge portion 164 that rotatably supports the flat plate portion 161 relative to the inner frame 150. For example, one side of the hinge portion 164 may be rotatably coupled to an upper portion of the inner frame 150, and the other side of the hinge portion 164 may be fixedly coupled to the flat plate portion 161.

Accordingly, the flat plate portion 161 may pivot between a horizontally lying position and an upright position that intersects the lying position, and be supported on the inner frame 150 of the case 101. The flat plate portion 161 may fold relative to the inner frame 150 while pivoting from the lying position to the upright position and may unfold relative to the inner frame 150 while pivoting from the upright position to the lying position.

The flat plate portion 161 positioned in the upright position is illustrated in FIG. 3, and the flat plate portion 161 positioned in the lying position is illustrated in FIG. 4. Although not illustrated, the side table 160 may further include a folding prevention stopper that prevents the flat plate portion 161 from unintentionally folding into the upright position when in the lying position.

The user may grasp the flat plate portion 161 positioned in the upright position by hand and pivot the flat plate portion to the lying position, or conversely, grasp the flat plate portion 161 positioned in the lying position by hand and pivot the flat plate portion to the upright position.

Although not illustrated in the drawings, the console module 100 may further include an actuator for pivoting a side table, which provides power to pivot the flat plate portion 161 of the side table 160. In this case, an input device for entering a command to pivot the plate portion 161 from the upright position to the lying position, or from the lying position to the upright position, may be provided on the bezel 153. The user may operate the input device provided on the bezel 153 to fold or unfold the flat plate portion 161 of the side table 160.

The console module 100 may further include the charging plate 128 capable of wirelessly charging portable electronic devices such as laptops or tablet computers. The charging plate 128 may, for example, be provided on an upper surface of the outer housing 102. Although not illustrated in the drawings, the console module 100 may further include a wired charging port capable of charging portable electronic devices via a wired connection.

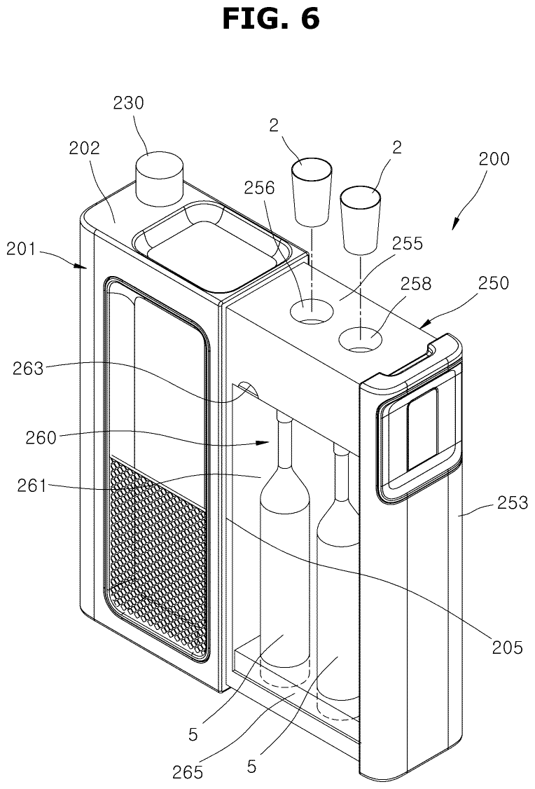

FIG. 6 is a perspective view of a console module according to another embodiment of the present disclosure. Referring to FIGS. 1, 2, and 6, a console module 200 according to another embodiment of the present disclosure may be rotatably installed on the dashboard 11 in place of the console module 100 illustrated in FIGS. 1 to 5. The console module 200 according to another embodiment of the present disclosure includes a case 201 and a connection portion 230.

The case 201 may include an outer housing 202 and an inner frame 250. The inner frame 250 may be inserted into the outer housing 202 to protrude from the outer housing 202.

The outer housing 202 may have an inner frame storage hole 205 into which the inner frame 250 is inserted. The inner frame storage hole 205 may allow the inner frame 250 to slide relative to the outer housing 202 and be inserted into the outer housing 202, or conversely, allow the inner frame 250 to protrude outward from the outer housing 202.

The case 201 may further include a bezel 253 on an edge portion of the inner frame 250 that is not inserted into the inner frame storage hole 205. For example, a user of the console module 200 may grasp the bezel 253 by hand and pull or push this bezel, allowing the inner frame 250 to protrude outward from the outer housing 202 or to be inserted into the outer housing 202.

Although not illustrated in the drawings, the console module 200 may further include an actuator for moving an inner frame, which provides power to protrude the inner frame 250 outward from the outer housing 202 or insert the inner frame 250 into the outer housing 202. In this case, an input device for entering a command to move the inner frame 250 relative to the outer housing 202 may be provided on the bezel 253. The user may operate the input device provided on the bezel 253 to automatically protrude the inner frame 250 outward from the outer housing 202 or insert the inner frame 250 into the outer housing 202.

The connection portion 230 connects the case 201 to the dashboard 11, allowing the case 201 to move between a non-use position and a use position. For example, the connection portion 230 may protrude from an upper portion of the outer housing 202 and be fastened to the central portion 13 of the dashboard.

The case 201 being in the use position refers to a state in which the case 201 protrudes further rearward compared to when in the non-use position. When the case 201 is in the use position, at least a portion of the case 201 may protrude further rearward than the rear end of the dashboard 11. In particular, the bezel 253 of the case 201 may protrude further rearward from the dashboard 11 so as to be closer to the driver seat 30 and the passenger seat 35 when in the use position compared to when in the non-use position. The case 201 may pivot between the non-use position and the use position, with the connection portion 230 as a pivot point.

The console module 200 may include an electronic device installed in the case 201. The electronic device may include a refrigerator 260, a cooling cup holder 256, and a heating cup holder 258. The refrigerator 260, cooling cup holder 256, and heating cup holder 258 may be installed in the inner frame 250.

The refrigerator 260 may, for example, be a wine cooler designed to store bottled liquids such as wine at a cold temperature that prevents freezing. The refrigerator 260 may include a cooling unit (not illustrated), a bottle holder 265, and an opening/closing door 261. The cooling unit cools the interior space of the inner frame 250, where items requiring refrigeration such as a wine bottle 5 are stored, to a refrigeration temperature of, for example, 1 to 10° C.

The bottle holder 265 may be installed in the interior space of the inner frame 250 to keep the wine bottle 5 in position without tipping over. The bottle holder 165 may have a groove in which the bottom of the wine bottle 5 is fitted.

The opening/closing door 261 may be installed on one side of the inner frame 250 to allow for opening and closing. When the opening/closing door 261 is opened, the interior space of the inner frame 250 is exposed, allowing the wine bottle 5 to be placed into the interior space of the inner frame 250, i.e., into the interior space of the refrigerator 260, or to be taken out from the interior space of the refrigerator 260. The side surface of the inner frame 250 may have a recessed handle groove 263 formed for the user to grasp the opening/closing door 261.

The cooling cup holder 256 and heating cup holder 258 may be installed on an upper surface of the inner frame 250. The cooling cup holder 256 may include a groove portion with a recessed groove formed to fit the bottom of a cup 2, and the cooling unit that cools the inner surface of the groove portion to a cold temperature. When the cup 2 containing a beverage is placed in the cooling cup holder 256, the beverage in the cup 2 may be kept cool.

The heating cup holder 258 may include a groove portion with a recessed groove formed to fit the bottom of the cup 2 and a heating unit that heats the inner surface of the groove portion to a warm temperature. When the cup 2 containing a beverage is placed in the heating cup holder 258, the beverage in the cup 2 may be kept warm.

The console module 200 illustrated in FIG. 6 includes the refrigerator 260, cooling cup holder 256, and heating cup holder 258 together, but this is exemplary. The console module of the present disclosure may include only one or two of the following: the refrigerator 260, cooling cup holder 256, and heating cup holder 258.

The refrigerator 260, cooling cup holder 256, and heating cup holder 258 are only examples of the electronic devices included in the console module of the present disclosure. The console module of the present disclosure may also include other types of electronic devices not illustrated in FIG. 6.

Although embodiments of the present disclosure have been described with reference to the accompanying drawings, these embodiments are provided for the illustrative purpose. It will be apparent to those skilled in the art that various modifications and equivalent embodiments can be made from these embodiments disclosed herein. Accordingly, the true scope of the present disclosure should be defined only by the appended claims.

What is claimed is:

1. A console module comprising:
a case positioned below a dashboard of a vehicle; and
a connection portion configured to connect the case to the dashboard and allow the case to move between a non-use position and a use position,
wherein, when moved to the use position, the case protrudes further in a rearward direction than when the case is moved to the non-use position.

2. The console module of claim 1, wherein the case is configured to pivot between the non-use position and the use position with the connection portion functioning as a pivot point.

3. The console module of claim 1, further comprising a side table including a flat plate portion configured to pivot between a horizontally lying position and an upright position that intersects the horizontally lying position, wherein the side table is supported on the case.

4. The console module of claim 1, further comprising a pocket installed on the case and including a pocket door configured to be opened or closed.

5. The console module of claim 1, further comprising an electronic device installed in the case.

6. The console module of claim 5, wherein the electronic device comprises at least one of a refrigerator, a cooling cup holder and a heating cup holder.

7. The console module of claim 1, wherein the case comprises:
an outer housing; and
an inner frame inserted into the outer housing and having a portion protruding from the outer housing.

8. A vehicle cockpit comprising:
a dashboard positioned in an interior space of a vehicle; and
a console module comprising:
a case positioned below the dashboard; and
a connection portion configured to connect the case to the dashboard and allow the case to move between a non-use position and a use position,
wherein, when moved to the use position, the case protrudes further in a rearward direction than when the case is moved to the non-use position.

9. The vehicle cockpit of claim 8, further comprising:
a driver seat positioned behind the dashboard in the interior space of the vehicle; and
a passenger seat disposed adjacent to the driver seat,
wherein, when moved to the use position, the case is positioned between the driver seat and the passenger seat.

10. The vehicle cockpit of claim 8, further comprising an actuator configured to provide power to move the case between the non-use position and the use position.
